(19) United States
(12) Patent Application Publication
(10) Pub. No.: US 2013/0080537 A1
(43) Pub. Date: Mar. 28, 2013

(54) Methods and Apparatus for Meeting Location Management

(71) Applicants: Maria Eugenia Protopapas, Canton, MI (US); Anthony Gerald King, Ann Arbor, MI (US)

(72) Inventors: Maria Eugenia Protopapas, Canton, MI (US); Anthony Gerald King, Ann Arbor, MI (US)

(73) Assignee: FORD GLOBAL TECHNOLOGIES, LLC, Dearborn, MI (US)

(21) Appl. No.: 13/241,680

(22) Filed: Sep. 23, 2011

(51) Int. Cl. G06F 15/16

(52) U.S. Cl. 709/205; 709/206

(57) ABSTRACT

A computer implemented method includes receiving a meeting notification lacking a meeting location designation. The method also includes searching at least one website for a possible meeting location. The method further includes selecting at least one possible meeting location from the at least one website based at least in part on one or more meeting attendees or a domain name associated with a meeting planner. Additionally, the method includes presenting the at least one possible location for verification and utilizing a verified location as the meeting location designation.

### TECHNICAL FIELD

The illustrative embodiments generally relate to methods and apparatus for meeting location management.

### BACKGROUND

The integration of vehicle computing systems, smart phones, remote computing systems and user data and applications has led to many opportunities for improving day-to-day user life. For example, in one instance, a user can upload a calendar from a PC, smartphone, server, etc. to a vehicle computing system, and then, through the vehicle computing system, the user can track appointments as the work day passes.

U.S. Pat. App. 2004/0220768 describes “A method for signaling a departure time comprising calculating a route between a departure point for a transport means and an arrival point and the required time for the journey. On the basis of a desired arrival time, a departure time for a user is established and is timely signaled to the user. The method can be carried out by a mobile data processing unit whereby appointment planner software can output not only the appointment which is to be observed but also the departure time to be followed in order to be on time for the appointment.”

U.S. Pat. App. 2010/0274865 describes “A computer-readable medium may include computer-executable instructions. The computer-executable instructions may include instructions for identifying an event that is scheduled to be attended by a user, determining a current location of a device associated with the user, determining an estimated amount of time that the user needs to travel from the current location to the event, and sending an alert to notify the user, the alert indicating the amount of time that is available to the user to travel to the event.”

U.S. Pat. App. 2010/0287024 describes “A method is provided for prompting a user to perform PIM-related acts based on dynamic location data. The user's current location is received and a PIM item is selected from the user's PIM system. The user's current location is compared to the location of the selected PIM item. Based on the comparison, a suggested user fulfillment action for the PIM item is suggested to the user.”

U.S. Pat. No. 7,813,950 describes “A computer-implemented method provides location-sensitive and time-sensitive calendaring to a wireless device, such as a cell phone, pager, PDA, etc. A user's calendar is maintained with a number of appointments, start times and end times for the appointments, meeting place and a list of attendees for the appointments. When the present time reading is within a predetermined minimum of a meeting start time of an appointment of a calendar of a user, the location of the user is determined based on the location of the wireless device. The location of the meeting place is also determined. Using historical data (of the user or others), the estimated time of arrival of the user at the meeting place is determined. If the estimated time of arrival is after the meeting start time, then a late message may be sent to the user and/or to the other meeting attendees.”

### SUMMARY

In a first illustrative embodiment, a computer implemented method includes receiving a meeting notification lacking a meeting location designation. The method also includes searching at least one website for a possible meeting location. The method further includes selecting at least one possible meeting location from the at least one website based at least in part on one or more meeting attendees or a domain name associated with a meeting planner.

Additionally, the method includes presenting the at least one possible location for verification and utilizing a verified location as the meeting location designation.

In a second illustrative embodiment, a computer implemented method includes receiving a meeting notification lacking a meeting location designation. The method also includes requesting a meeting location from a meeting planner. The method further includes receiving a response to the request, including the meeting location. Also, the method includes utilizing the meeting location as the meeting location designation.

In a third illustrative embodiment, a computer implemented method includes receiving a meeting notification lacking a meeting location designation. The method also includes retrieving GPS coordinates of a user vehicle in a parked state at or after a meeting start time. Further, the method includes storing the GPS coordinates of the user vehicle as an address with respect to at least one contact corresponding to at least one meeting invitee.

### BRIEF DESCRIPTION OF THE DRAWINGS

FIG. 1 shows an illustrative vehicle computing system;

FIG. 2 shows an illustrative example of a meeting location determination process;

FIG. 3 shows an illustrative example of an address update process;

FIG. 4A shows an illustrative example of an address obtainment process; and

FIG. 4B shows a second illustrative example of an address obtainment process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

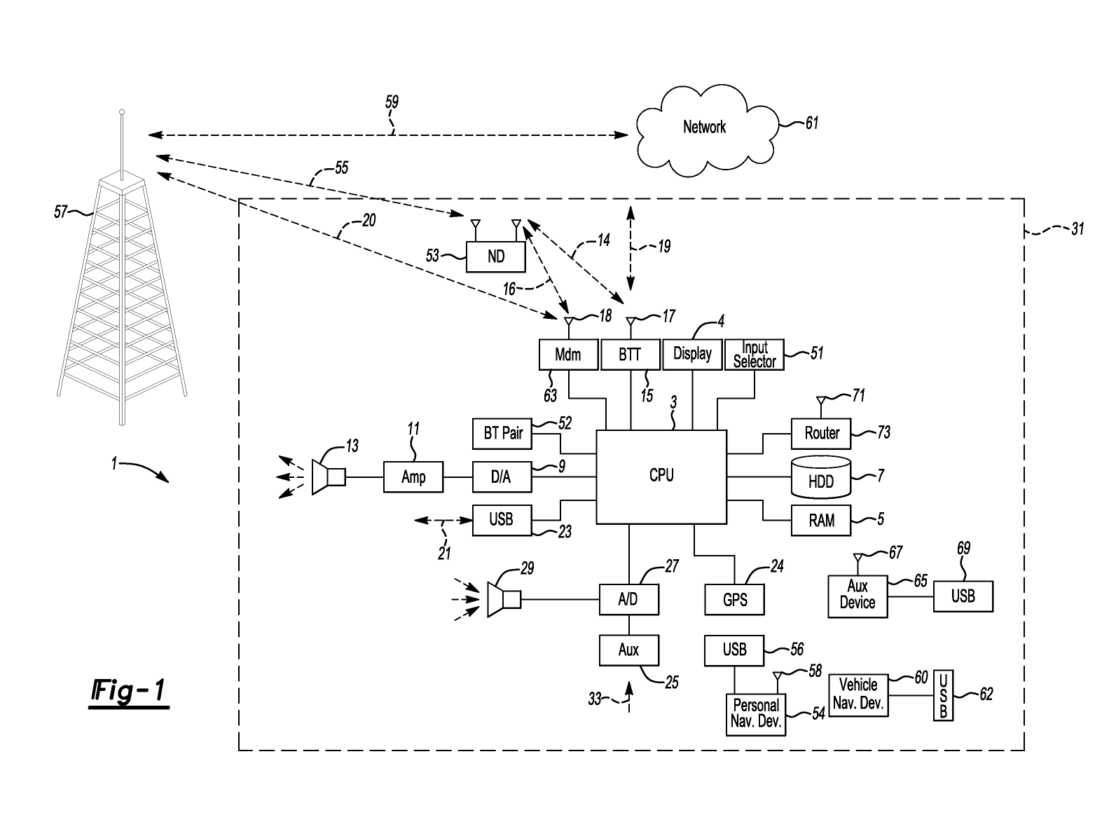

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

By integrating a calendar (through, for example, without limitation, periodic uploads) into a vehicle computing system is that it allows a user “on the go” access to the calendar. By managing the calendar, the vehicle computing system can provide directions to a meeting location, contact with meeting members, and inform a mobile user if they need to head to a given meeting. Further, the VCS can inform a user if they are likely to be late to a meeting, for example.

Late arrival to a meeting can be determined, for example, by checking a current vehicle GPS location and determining the amount of time required to reach a meeting location. This can be based on fixed data (such as a route, estimated/known speed limits, etc.) and/or dynamic data (traffic, vehicle fuel level, weather, construction, etc.).

If the user is likely to be late to a meeting, the system can notify one or more meeting members of the user's current status. By utilizing contact information included with the meeting notice, or contact information stored in an address book, the VCS can call, email, text or otherwise contact one or more meeting participants. If a phone call is made, an open communication channel can be established, or a “canned” message can be delivered. The message (which could also be sent in text or email format, for example) could be as simple as a late notification, or could include additional data such as a projected arrival time, a user's current location, and/or any other pertinent information that could be useful in determining when a user will arrive. The message could further include information for contacting the user directly in the vehicle, if desired (for example, without limitation, a number to call, if the meeting members wish to conference the user in).

Although the VCS can provide routing and late-notification functionality, both features will be potentially limited or downright unusable if no location for the meeting is not known by the VCS. At least one aspect of the illustrative embodiments deals with obtaining the location of a particular meeting for use by the system.

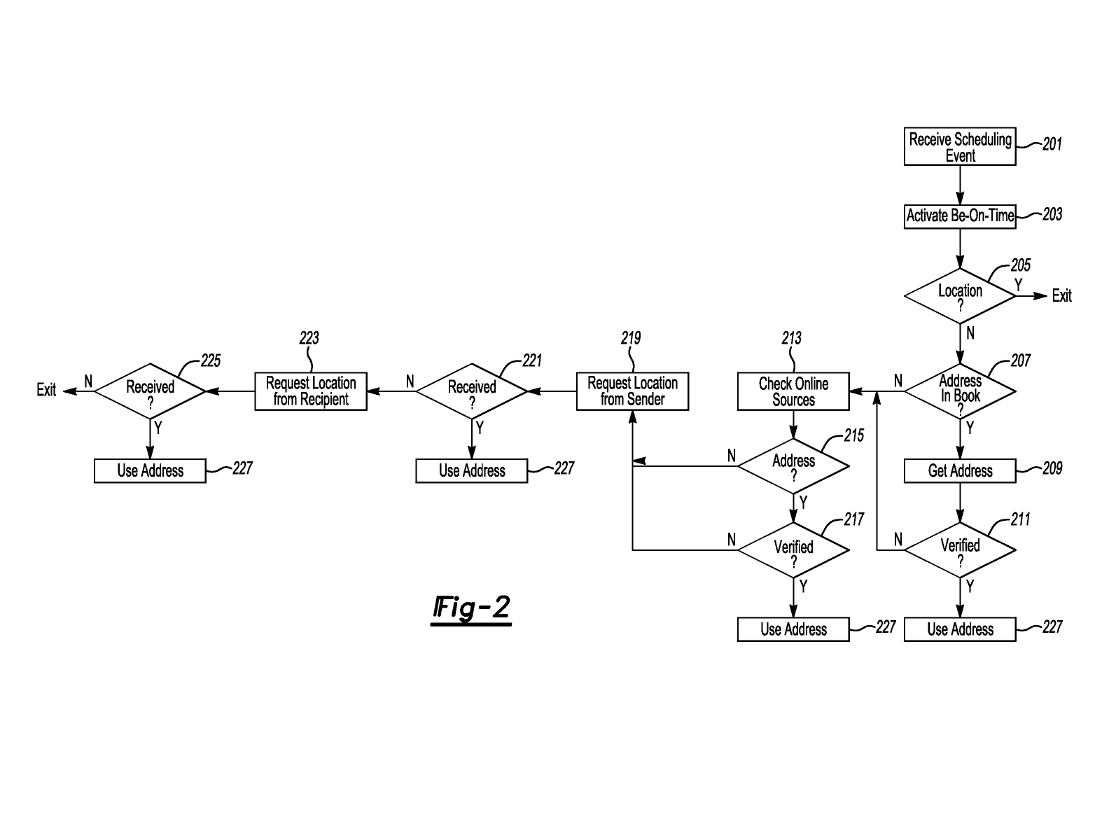

FIG. 2 shows an illustrative example of a meeting location determination process. In this illustrative embodiment, a scheduling event 201 (such as, but not limited to, a meeting notification) is received. The notification can be received in a vehicle computing system, a computing system remote from the vehicle, or by a smart phone application, for example. In at least one embodiment, described in greater detail herein, a vehicle computing system or remote system in communication with the vehicle computing system, that provides, for example, routing and other services, receives the scheduling event or a copy of/notification about the scheduling event.

In conjunction with receipt of the scheduling event, a “be on time” or other sub-routine is activated 203, wherein the meeting destination is a desirable input. If there is a location affiliated with the event 205, the process can exit, since the location is known and the subroutine has the desired destination input.

If there is no location, however, the process will attempt to obtain the location. In this embodiment, the process attempts to obtain the location through “less obtrusive” processes initially, although these processes may also be less efficient. In another embodiment the process may attempt a more efficient ordering of address obtainment, only resorting to less obtrusive, potentially more inefficient measures if the primary measures fail.

In this illustrative instance, the process first checks a contact list, address book, database, etc. for possible addresses 207. In one instance, if the sender of the notification is found, the process may first try that address. In another instance, addresses of the sender and multiple recipients may be found, and those addresses can all be tried 209. For example, if four addresses are found relating to invitees (which may or may not include the person running the process), a list of possible addresses can be presented to the user for verification/selection 211.

If one of the addresses is verified 211, the process can instruct the location-related subroutine to use that address. If no addresses are found, or if an address cannot be verified/selected, the process may proceed to checking online sources 213.

Online sources can include a variety of potential resources. Company websites, company contact lists/databases, domain registrations for domain names, social media, etc. can all potentially be polled for a list of addresses. For example, without limitation, a company can give access to an internal database to all calendar programs provided to employees. In this instance, it may be relatively easy to find a meeting planner's address.

Or, in another non-limiting example, a social media site such as LINKEDIN may contain a business address for one or more recipients. Domain registration sites may be useful in the case of small businesses, with only one location, as may company websites with an address easily accessible by a bot designed to parse the site. Numerous online resources can be utilized in the “background” to find one or more addresses 215 to present to a user for selection/verification 217.

Again, if selected/verified, the address can be applied to the location-related subroutine 227.

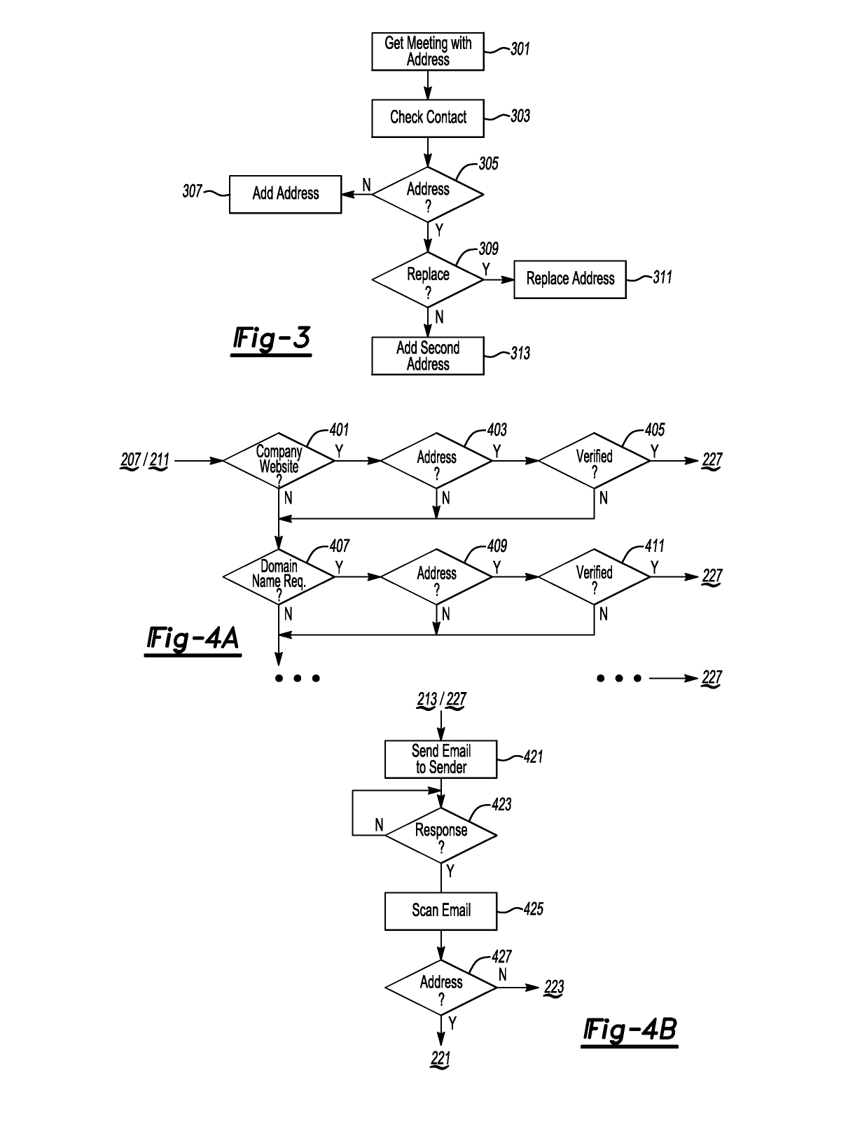

If the online resources are incapable of producing a suitable or correct address, the process may request that the meeting planner provide an address 219. This can be done in a variety of manners, some of which are detailed for exemplary purposes with respect to FIG. 4B. If the meeting planner provides an address 221, in this example, the selection/verification step is bypassed, under the assumption that the meeting planner will provide a correct address. Selection and verification can also be implemented here if desired, and, in either event, the address may be used for the location-related subroutine 227.

If the meeting planner does not provide an address (for example, without limitation, if the meeting planner is unavailable or the meeting notice is received last minute), the process can ask the user to input a location 223. If a location is received from the user 225, the process again (although not necessarily) assumes that the address is correct and provides that address to the location-related subroutine 227.

This process can also be implemented a plurality of times, if desired. For example, upon receipt of the notice, the process may once be implemented if the address or location is missing. If the process is unsuccessful at obtaining an address, some period of time later, or, for example, without limitation, when it is detected that the meeting is temporally proximate and/or the user is en-route to what is likely the meeting (since the location is still presumably unknown), the process can be repeated again. Even if the user does not enter an address until on the way to the meeting, functions such as a “running late” function can be implemented at that time, using the correct location.

FIG. 3 shows an illustrative example of an address update process. In this illustrative example, the process is designed to help create a searchable list, database or updated contact list of addresses usable by the FIG. 2 routine in the future. In this manner, the user can use information obtained with regards to one meeting to augment the speed of future meeting address updates.

In this illustrative example, the process recognizes that an address has been associated with a meeting request 301. The address/location could have come included with the meeting notice, or it could have been obtained and/or verified/selected through an exemplary process, such as, but not limited to, the processes described with respect to FIG. 2.

In one non-limiting example, not shown in detail, the process could recognize that a meeting location had not been entered. Instead, when the user arrived at a destination in temporal proximity to the meeting, a location could be saved and associated with that meeting. Although not perfectly precise in many instances, this could provide at least an approximate address for similar future meetings.

Once an address has been confirmed/detected/determined, the process may check a contact 303 to see if an address is associated therewith 305. In one instance, the contact is the meeting planner, in another instance, the “contact” could be each meeting attendee, and in still another exemplary, non-limiting instance, a “contact” could be created that refers to all the meeting recipients. In the last instance, future meetings between persons A, B and C could then have a previously used address affiliated therewith.

If there is no address currently affiliated with whatever contact(s) the system checks (or creates, possibly, in the absence of a corresponding contact), the address for the meeting is added 307. If an address exists, the user is asked if they wish to replace the old address 309. Selecting replacement will result in overwriting of the address 311, while declining replacement will/may result in addition of a second address (which could also include a user query option).

FIG. 4A shows an illustrative example of an address obtainment process. In this illustrative embodiment, the process is searching the interne for possible addresses. This is just one of many possible ways to “automatically” obtain an address, and the examples shown with respect to this figure are merely exemplary internet sources.

First, in this illustrative embodiment, the process checks to see if a company website exists 401. The website can then be checked to see if, for example, without limitation, a searchable directory, contacts section, or location address is present 403. If there are one or more possible addresses, the possibilities can be presented and verified/selected 405. Failure to find a website, address or received selection/verification may result in the process moving to a next step 407.

Next, in this example, a domain name registration is checked 407. For example, if an email came from person X @company.com, company.com could be checked to see who owns the site. If there is an available registration, and if there is an address associated with the registration 409, the process may present the address for verification 411.

Numerous other online sources can also be polled, scanned, parsed and checked for possible addresses. It is also possible that the system may apply some logic to the addresses to weed out certain addresses. For example, if a person is in Michigan at 1 PM on a Tuesday and has a meeting in two hours, and the only available address is in Florida, it is unlikely that the meeting will take place there, unless the meeting is a conference call. In either event, a location-related subroutine such as a direction providing process or “running late” notification may elect to ignore the Florida address.

FIG. 4B shows a second illustrative example of an address obtainment process. In this illustrative example, the process is attempting to obtain an address from a meeting planner. The process sends an email (or other notification) to the meeting planner requesting an address 421. The process then waits for a reply. For example, the process can periodically scan an inbox for an expected reply email, or employ another suitable means of detecting a reply 423.

Once a response is detected the process can parse the response to determine if an address has been provided therewith 427. If there is an address, the process can utilize the address in an appropriate manner. Even if the meeting planner does not reply, the request may cause them to update the meeting notice, thus achieving the desired result.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer implemented method comprising:
receiving a meeting notification lacking a meeting location designation;
searching at least one website for a possible meeting location;
selecting at least one possible meeting location from the at least one website based at least in part on one or more meeting attendees or a domain name associated with a meeting planner;
presenting the at least one possible location for verification; and
utilizing a verified location as the meeting location designation.

2. The method of claim 1, wherein the at least one website includes one or more social media websites.

3. The method of claim 1, wherein the at least one website includes a company website.

4. The method of claim 3, wherein the at least one website further includes an online company directory.

5. The method of claim 1, wherein the at least one website includes a domain name register website.

6. The method of claim 1, wherein the at least one website is located on a company intranet and includes a company directory.

7. The method of claim 1, wherein the one or more meeting attendees include the meeting planner, and wherein if an address associated with the meeting planner is selected, that address is presented as a primary option.

8. The method of claim 7, wherein the primary option is presented as an only option, at least initially.

9. The method of claim 1, further including storing the meeting location designation with respect to at least one contact in a contact book.

10. The method of claim 9, wherein the at least one contact includes the meeting planner.

11. The method of claim 9, wherein the at least one contact includes all of the meeting recipients.

12. The method of claim 9, further including creating a new contact based on all recipients of the meeting notification and storing the meeting location with respect to the new contact.

13. A computer implemented method comprising:
receiving a meeting notification lacking a meeting location designation;
requesting a meeting location from a meeting planner;
receiving a response to the request, including the meeting location; and
utilizing the meeting location as the meeting location designation.

14. The method of claim 13, wherein the requesting includes sending an email to the meeting planner.

15. The method of claim 13, wherein the requesting includes sending a text message to the meeting planner.

16. The method of claim 13, wherein the response is in the form of an email.

17. The method of claim 13, wherein the response is in the form of a text.

18. The method of claim 13, further comprising saving the meeting location with respect to a contact relating to the meeting planner.

19. A computer implemented method comprising:
receiving a meeting notification lacking a meeting location designation;
retrieving GPS coordinates of a user vehicle in a parked state at or after a meeting start time; and
storing the GPS coordinates of the user vehicle as an address with respect to at least one contact corresponding to at least one meeting invitee.

20. The method of claim 19, wherein the at least one meeting invitee is the meeting planner.
